(19) United States
(12) Patent Application Publication
(10) Pub. No.: US 2020/0218521 A1
(43) Pub. Date: Jul. 9, 2020

(54) Method for managing identity value in software development

(71) Applicant: VIETTEL GROUP, Ha Noi City (VN)

(72) Inventors: Quang Diep Pham, Ha Noi City (VN); Van Hien Le, Ha Noi City (VN)

(73) Assignee: VIETTEL GROUP, Ha Noi City (VN)

(21) Appl. No.: 16/669,390

(22) Filed: Oct. 30, 2019

(30) Foreign Application Priority Data
Jan. 3, 2019 (VN) 1-2019-00042

(51) Int. Cl. G06F 8/41

(52) U.S. Cl. CPC G06F 8/433; G06F 8/42

(57) ABSTRACT

A method to help developers manage ID values for big systems includes assigning an array with N values, an index is the value of allocated pointer, initially 0. Anytime an allocate function is called, this index value increases by 1 and is reset to 0 when the previous value is (N−1). The system calculate the fit position to assign released value in the array which is ready for allocation. If the system needs more than N values, the allocation request will be rejected. The method is useable for high performance and can be acceptable for big systems depending on the strategy to manage id values from the developer.

### DEFINITION

Methods for managing identity value in software development in accordance with the systems need to manage the large number identity values that will be allocated to manage the object, session, user by unique value . . . and allow reuse of the value which is released (when the session is ended, user is removed . . . ). In this case, this method focus that allocating value is not needed to check the uniqueness of value (by processing when releasing the allocated value).

### DESCRIPTION

In the system providing for the large number of users like telecommunication systems, websites, Internet of Things (IoTs) system . . . , we will need the methods to manage ID for user, device, session . . . which ensure that ID value is unique in anytime and can be reused it when it is released. Basic methods include that when we allocate new values we need to check all of the used values to ensure that the new value is unique, but it take too much time and affects performance for the systems which supports managing the number of sessions in the millions.

This method is given to help the developer manage ID values better for big systems and it is defined as follows:

Assign array with N values that can be used.

Index is value of allocated pointer which initiate 0. Anytime allocate function is called, this value increase by 1 and reset to 0 when the previous value is (N−1).

The system calculates the fit position to assign released value in the array which is ready for allocation.

If the system needs more than N values, the allocate request will be rejected.

This method can be used for high performance but it also has disadvantage points in that it needs to initiate the memory to store all useable values, for example: if the system needs to manage all of integer value with 4 bytes per value, we need to initiate 4*2³²−1=16 Gb but it can be acceptable for the big systems and depend on the strategy to manage id values from developer.

### TECHNICAL BACKGROUND

This method is given focus on allocating fast without checking uniqueness of value by calculating to ensure that if the number of allocated id is not over a limit on the number ID of the system, it only gets value at the Index (allocate pointer).

i) Initiation:

N: number of useable values;

M: array to store all of useable values (can use mapping if useable value is not integer value to reduce initiation memory at the first time);

Index: position of allocation pointer in array M (initially 0).

Remain: number of allocated values (initially Remain=N).

ii) When allocating value:

Step 1: Check Remaining >0 or not.

Step 2: Update status of system after allocation (if pass the step 1). iii) When releasing value:

Step 1: Calculate to assign released value to array M.

Step 2: Update status of system.

### BRIEF DESCRIPTION AND DRAWINGS

FIG. 1: Description of initiation value.

FIG. 2: Description for processing allocate request.

FIG. 3: Description for processing release request.

FIG. 4 Description for initiating array M with N useable value.

FIG. 5: Description for processing update when Index is first of array M.

FIG. 6: Description for processing update when Index is K−1 of array M (0<K<N−2).

FIG. 7: Description for processing update when Index is last of array M.

FIG. 8 and FIG. 9 Description for processing update when release value, Pos (the result of formula when release) can before Index (FIG. 5) of after Index (FIG. 6) or equal Index (if Remain=0).

### DETAIL OF INVENTION

This methods is described as the below:

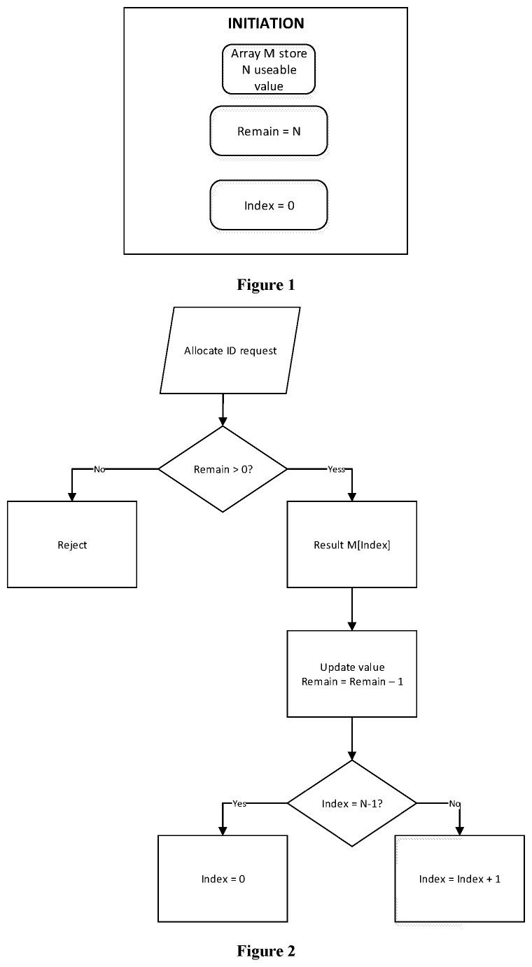

i) Initiation: (FIG. 1)

Array M store all of useable values (N)

Remain=N (number of useable values)

Index=0 (position of allocation pointer in array M)

ii) When allocating value: (FIG. 2)

Step 1: Check value of Remain.
Remain>0: move to step 2
Remain=0: reject request

Step 2: allocated value is M[Index]. Update status of system:
Remain=Remain−1
Index=Index+1

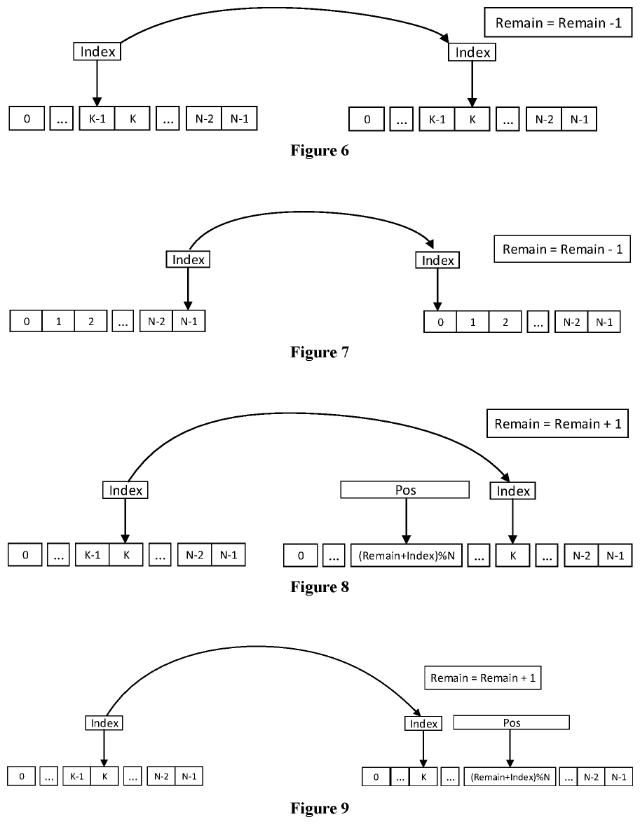

Detail FIG. 5, FIG. 6, FIG. 7

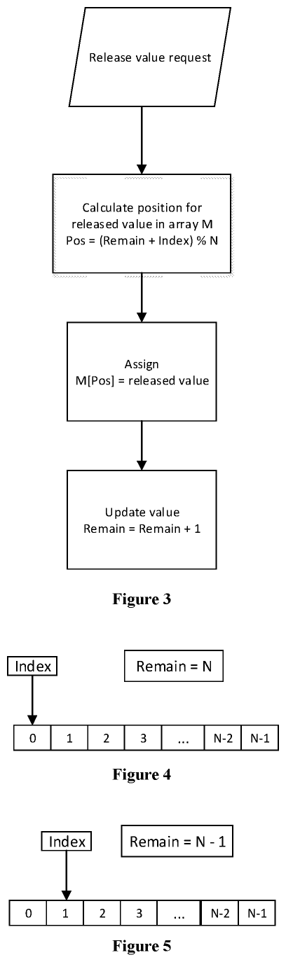

iii) When release value: (FIG. 3)

Step 1: calculate the position for released value
Pos=(Remain+Index)%N

Pos is positon in array M which is assign released value.

Step 2: Update status of system:
M[Pos]=released value
Remain=Remain+1

Detail in FIG. 8 and FIG. 9.

### Application

Using in module to Manage ID of Mobility Management Entity—MME, include: Mobile Identity, Tunnel ID which ensure unique value in one node MME.

Compare result when deployed on Personal Computer—PC and Server

| | |
|---|---|
| Hardware Configuration | Intel ® Xeon ® E5-2690 v4 2.6 GHz |
| | Number of Core: 2 |
| | RAM: 8 Gb |
| Programing language | Erlang |
| Method to store data | ets |
| Memory capacity initiate | 8 Mb (2 million integer values 4 bytes) |
| Speed to allocate value | 200,000 transaction per second (tps) |

Using in Mobility Management Entity (MME) in 4G Core System:

| | |
|---|---|
| Hardware Configuration | Intel(R) Xeon(R) CPU E5-2697A v4 @ |
| | 2.60 GHz |
| | Number of core: 32 |
| | RAM: 128 Gb |
| Programing language | Erlang |
| Method to store data | ets |
| Memory capacity initiate | 8 Mb (2 million integer values 4 bytes) |
| Speed to allocate value | 300,000 tps |

### Effect

Allocates values fast, can be used in high performance systems;

Easy to program with no limited language.

What is claimed is:

1. Methods for manage identity value in software development include the steps of:
(i) Initiate a value: in an array M store N useable values; Remain=N (number of useable value in a system); and an Index=0 (position of an allocation pointer in M);
(ii) Allocate value:
Step 1: Check value of Remain>0 or not
Step 2: Update state of the system if pass Step 1:
Allocate value M[index];
Update data:
Index=Index+1 if Index<N−1
Index=0 if Index=N−1
Remain=Remain−1;
(iii) Release value:
Step 1: calculate position for a released value in M (Pos):
Pos=(Remain+Index)%N
Step 2: Update data:
Remain=Remain+1
M[Pos]=released value.
